(19) United States
(12) Patent Application Publication
(10) Pub. No.: US 2014/0067934 A1
(43) Pub. Date: Mar. 6, 2014

(54) System and method to provide a social network layer over the World-Wide Web and other networks

(71) Applicants: Sarah Ware, Washington, DC (US); Justin Jacob Kline, Washington, DC (US); Rahf Noor, Frederick, MD (US)

(72) Inventors: Sarah Ware, Washington, DC (US); Justin Jacob Kline, Washington, DC (US); Rahf Noor, Frederick, MD (US)

(21) Appl. No.: 13/600,072

(22) Filed: Aug. 30, 2012

(51) Int. Cl. G06F 15/16

(52) U.S. Cl. 709/204

(57) ABSTRACT

A method and system for a new form of computer-implemented social network. Existing social networks limit users interactions to the context provided by social networking clients, and also limit discussions of content to short clips with links back to the original website. The presented method and system enable users to interact with each other within the context of a third-party web page. Users can mark up a third-party web page to leave each other notes, chat, or highlight text, all without requiring any modification to the server-side source code of the third-party web page.

### CROSS-REFERENCE TO RELATED APPLICATIONS

Not Applicable

### BACKGROUND OF THE INVENTION

1. Field of the Invention

The current invention relates to software systems that provide social networking functionality as well as software systems that enable the annotation of documents.

2. Description of Related Art

Social networks that are accessible to users over the Internet or via applications that run on mobile devices and client computers have become a popular forum for networking and communication over the last several years. A social network generally allows users to share content with each other based on a variety of factors, including the functionality offered by the network. The shared content may include, e.g., user-generated text, photos, images, and music. Users are generally connected to others on the social network, and a user may be presented with “updates” involving the activities of others who are connected to that user. Currently, social networks are hosted on servers used by the social network provider. Additionally, in some social networks, third-party content (outside network content) may be shared with other users by extracting quotes, images, or other portions of that content, or providing hyperlinks from the social network site to the external material.

Some social networks (e.g., Twitter®) use a subscription or list model, where users “follow” or put other users on a “list,” so that updates from followed and listed users will appear in the stream of updates available in the software client of following users. Other social networks (e.g., Facebook® or LinkedIn®) use a “friend” model, where one user will request a connection with another user; if the connection is accepted, the users can see each other's updates through the social network. There are other social networks that use a combination of both types of approaches (e.g., Google+®).

Updates that occur on current social networks are generally based on one of two approaches: pushing updates out to other users using a special protocol designed for communicating within that network (e.g., Twitter® or Foursquare®), or posting updates to a single site where other users can view them (e.g., Facebook® or Pinterest®) through a Web browser or client application. Some social networks provide both standalone software clients (including mobile clients) and Web sites.

Updates to current social networks often can be distributed at several different levels of granularity and restrictions on other user or third-party access, including public (meaning that any one with access to the social network can see them); groups that a user may choose to join, but where the user has no control over the membership of that group; or lists of friends or followers who can converse with a user directly.

Many social networks allow users to post a Uniform Resource Locator (URL), which provides a link to a web page. The URL must be opened and the content available on it viewed in a browser window external to the social network. That is, a web page referenced by the URL can be viewed or found from the social network, but the web page content is not part of the social network's content. Some social networks also allow short quotations or images from third-party web pages to be posted by users, although the content is still viewed through the social network. Moreover, sharing such content requires either that a user copy and paste the content into the social network site or that the third-party web page be modified to include functionality for sharing it with others in a particular social network, such as a Facebook “like” button or a LinkedIn “share” button that might be present on a web page.

One disadvantage of these networks is that they do not allow users to interact with an entire third-party web page within the social network's walls. Specifically, they do not allow a user to mark up specific content within a web page, e.g., to highlight interesting text, add notes within the web page itself, or provide a mechanism for sharing and discussing the content of the web page being shared.

Integrated sharing functionality also requires that third-party web sites modify their pages to include buttons that allow a user to share that content in a particular social network. Networks that are not expressly supported by a web site are at a serious disadvantage.

It would be beneficial to build a social network that allows users to interact and share information directly on a third-party web page, in the way that information is shared and commented on in the current social networks (without requiring modification of the server-side source code). This social network allows users to connect and interact directly on any web page on the Internet and comment/chat about information available on the World Wide Web.

The ability to directly annotate web pages is known in the art. For example, the Scrible® system provides a tool for annotating web pages, including highlights, notes and allows for modification of certain characteristics of the page text (e.g., bold, italics, and text color). The Scrible® tool runs within a web browser. When a user annotates a web page with this system, a copy of the entire web page is stored by the tool with the user's annotations. A user may also send a link to an annotated copy of a web page to other specified users by email or share the link on certain preexisting social networks like Facebook® or Twitter®. And annotated copies of the content of those web pages are stored on a Scrible® server.

Scrible® does not, however, provide a social network for users that sits on top of the Web and is accessible through a browser; on Scrible®, users cannot interact with each other on a live or dynamic web page. Rather, Scrible® caches web pages on its servers and presents the annotated pages from its database to users. As a result, Scrible® users do not navigate naturally through the live World Wide Web—by clicking through hyperlinks and drilling down on web pages from search results—while still viewing annotations stored with the Scrible® tool. Instead, each Scrible® annotated page must be called from a Scrible® server and loaded separately, even if a directly hyperlinked web page is annotated by the same user.

That is, a Scrible® user must separately load each annotated page from his personal Scrible® library, and the context of the linked pages is lost with this linear annotation recall system. Also, activating a hyperlink found on a page recalled from a Scrible® server will take a user to the original version of the page, which is then displayed without any annotations that might be associated with that page in the Scrible® server storage.

Thus, there is a need for a social network that allows users to navigate the World Wide Web and view other users' annotations of its content without having to leave the existing and current context of the dynamic Web behind.

Such a network allows new forms and methods of information sharing in a variety of use settings beyond simply sharing web content with friends. For example, members of a class at a university could share comments on a blog post, electronic articles, the professor's handouts, an ebook, etc. by marking up the web pages on which that information is located. As another example, a work group within an enterprise could mark up and share web research or internal network resource materials with such a social network overlay that interacts with internal resources and the web.

### BRIEF SUMMARY OF THE INVENTION

The present invention provides a new form of social network. Conceptually, this social network is transparently overlayed on top of the existing World Wide Web, enterprise networks, or other networks such as private or hybrid clouds. Users share content with each other by marking up web pages or internal resources using a variety of annotation tools. So long as a user is logged into the social network, when the user loads a web page, the user will see his annotations to that web page or those made by connected users. Similarly, any annotations made by the user will be visible to other users connected to him.

Some embodiments also allow users to create chat rooms on any web page that give connected users the ability to comment on content available on that page. A central feeds display page shows available marked up web pages.

The result is a social network for sharing thoughts and information about content in a new way.

Embodiments of the present invention allow users to connect to each other in a variety of ways. Some embodiments allow users to follow or subscribe to the markups created by other users. Followed users' markups appear in the feeds of their followers. Some of these embodiments will notify followers of new markups so that followers can actively seek out and review those new marked up web pages. For example, a journalist or professional commentator might be followed by a number of users who are interested in seeing their marked up content. Such an embodiment might provide a news feed that displays a list of marked up web pages. Markups of followed users can also be selected to be visible when a follower happens to navigate to a page the followed user has already marked up.

Embodiments of the invention may also use a “friend” model for connecting users. In such a model, a user identifies another user as a friend and sends a request to that other user. If the requested user agrees they should be connected, the two users become connected as friends and can see each other's annotations.

Embodiments may also use public or restricted groups for connecting users. Groups may be used, for example, to connect members of a high school or students in a university course. In such groups, students can interact with each other on web pages that are relevant to course material. Students might highlight particular text they find important or attach notes. A professor might record a video or audio message that is then attached to different parts of a single web page. The students can use a chat room for collaborating on and discuss the web page content, allowing them to interact with each other and the professor while still viewing the live web page itself.

Some embodiments also allow a user to identify other users who are geographically close by. In such embodiments, the user can see markups from those users who can be located using geolocation services. The present invention may also be used on an intranet or use a company directory to limit access to employees, or even to particular groups of employees.

For enterprise versions of the application, all data will be stored on a secure server—separate from the free consumer version—and access will be based on the enterprise user's email address. For example, users from Georgetown University would need to use their georgetown.edu email address in order to register as a member of the private University group. All content visited/conversations created by that user would only be accessible to other users that have registered with their institution's email address.

Chat rooms and other markups can be secured using known encryption and access controls techniques and technologies. For example, stored markups can be stored on the server in encrypted form and markups can be transmitted to a browser using encrypted communications. Chat rooms can be further secured by using such access controls as access lists (which list the users who may access that information) and/or password authentication.

The present invention provides a number of markup tools, including highlighting text, adding text notes, drawing shapes around elements of a web page, adding images to a web page, embedding audio or video, and a chat area. Each markup may optionally include a visual indicator associated with the user who added it. This visual indicator could be, for example, the display of a user name and image (such as an avatar) next to the annotation or an information box that appears when a user mouses over the markup.

The present invention uses software running within a web browser, such as a bookmarklet or browser plug-in. A bookmarklet takes advantage of the fact that a URL can contain Javascript by using the “javascript:” protocol. When the bookmarklet is active, it communicates with a server to store and retrieve markups associated with the currently displayed web page. The bookmarklet also provides the markup toolbar to allow the user to mark up the currently displayed web page.

When the user navigates to a web page, the browser extension contacts a server to retrieve any markups for that web page that should be displayed to the user. Once the markups are received, the browser extension modifies the Document Object Model (DOM) (see http://www.w3.org/DOM/ for more information) for the currently displayed web page so that the markups are displayed to the user. This modification can be performed with a standard language such as Javascript or Java, or using the extension APIs provided by the particular browser.

The users' markups are stored in a database. The database allows retrieval of markups by URL. Each markup is serialized and stored in a way that identifies the location of the markup within the DOM structure. The browser extension uses this location to modify the DOM of the displayed web page.

In certain circumstances, a web page may be modified after a markup is applied. As a result, the reference to the location in the DOM of a markup could be inaccurate. Optionally, the markup record includes some description of the text or web page element being marked up. This allows for searching the DOM to find the location of the markup.

One of the most notable features is that this communication occurs real-time. For example, a group of friends could meet up on the URL www.cnn.com at the same time, point out certain articles, and discuss the current events being displayed on this domain through a chat feature. In essence, every web URL becomes a room that people can meet in and interact with the content they're viewing together (i.e., www.cnn.com?fantasy would be a different room than www.cnn.com). This allows users to create their own dimensions of content and communication layers on live web pages that are not currently available through other social networks.

This social network also allows users to easily identify and share useful or interesting content within a web page. The social network also lets users interact with each other directly on any web page the users decide to meet on—or serendipitously—come in contact with when browsing information available on the web, for example, through a chat application and real-time marking and sharing of those marks.

This technology can also be used in educational settings by centering the classroom curriculum and discussion on any web page or group of pages on the Internet; where people can chat and mark up certain Internet content, and discuss and view those comments and mark ups in real-time. The invention will be especially useful for extending the online classroom setting to any web page in an easy-to-use bookmarklet.

These features provide important advantages over current social network applications, which generally allow sharing a URL to an entire web page or a particular image, and not specific text or areas of a page. However most of these types of social networks are analogous to clipping images, comments, or other content out of a book. The present invention allows users to stay on the page they've visited and interact with other users sitting on and interacting with that particular page. Moreover, the present invention works with any preexisting third-party web page without requiring modification of the web page source code at the server.

### BRIEF DESCRIPTION OF THE SEVERAL VIEWS OF THE DRAWINGS

FIG. 1 shows a model of user interaction using the present invention.

FIG. 2 shows a screenshot of an exemplary embodiment of a feed display page.

FIG. 3 shows an exemplary web page marked up using the present invention.

FIG. 4 shows a computer hardware configuration for the present invention.

FIGS. 5A-5B show a computer software configuration for the present invention compared to a standard Web browser configuration.

FIG. 6 shows a method for displaying markup on a third-party web page.

FIGS. 7A-7E show a data structure for storing markups in a database.

### DETAILED DESCRIPTION OF THE INVENTION

The present invention is a new form of social network that sits on top of and interacts with the World Wide Web. The present invention layers user markups on top of the existing World Wide Web. Users interact with each other by leaving markups on web pages, which are then viewed by other users. The markups go into a feed, where they can be viewed, in a common location, by other users. Instead of simply linking to a web page, however, items in the feed link to a web page that is wrapped so that users can mark up the web page and view others' markups on the page. For example, a user can highlight text, leave comments, mark sections with boxes, or even host or participate in a chat on the third-party web page itself.

The present invention is independent of the third-party web page content, meaning that the third-party content does not need to be modified to support it. Any standard web page can be used for social interaction among users using the present invention. No server-side source code needs to be changed for the present invention to work.

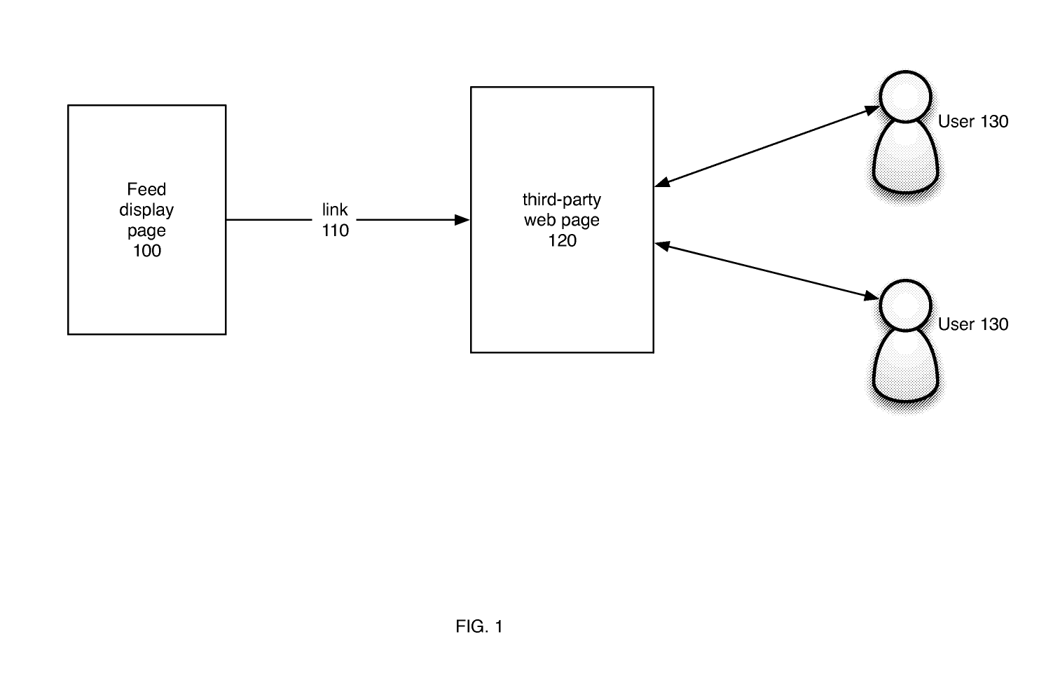

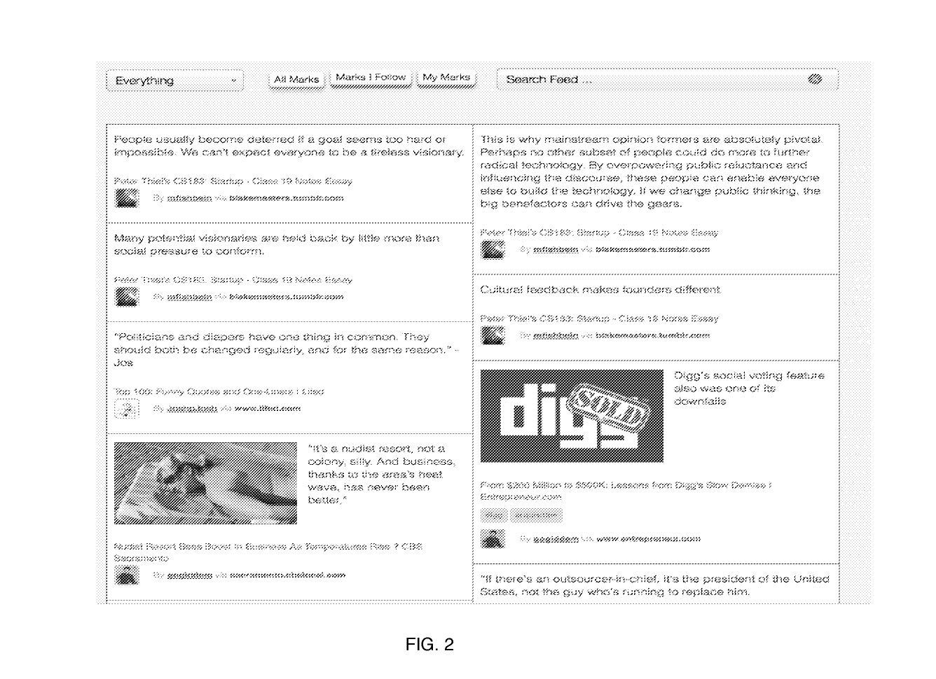

FIG. 1 illustrates possible user interaction through the system of the present invention. A feed display page 100 contains links 110. An exemplary screenshot of a feed display page 100 is shown in FIG. 2. Each link 110 is displayed along with other information about the link 110. For example, information about the user 130 who created the link 110 might be displayed, along with some text selected by the user 130. Selecting the link 110 loads a third-party web page 120 into a user's browser.

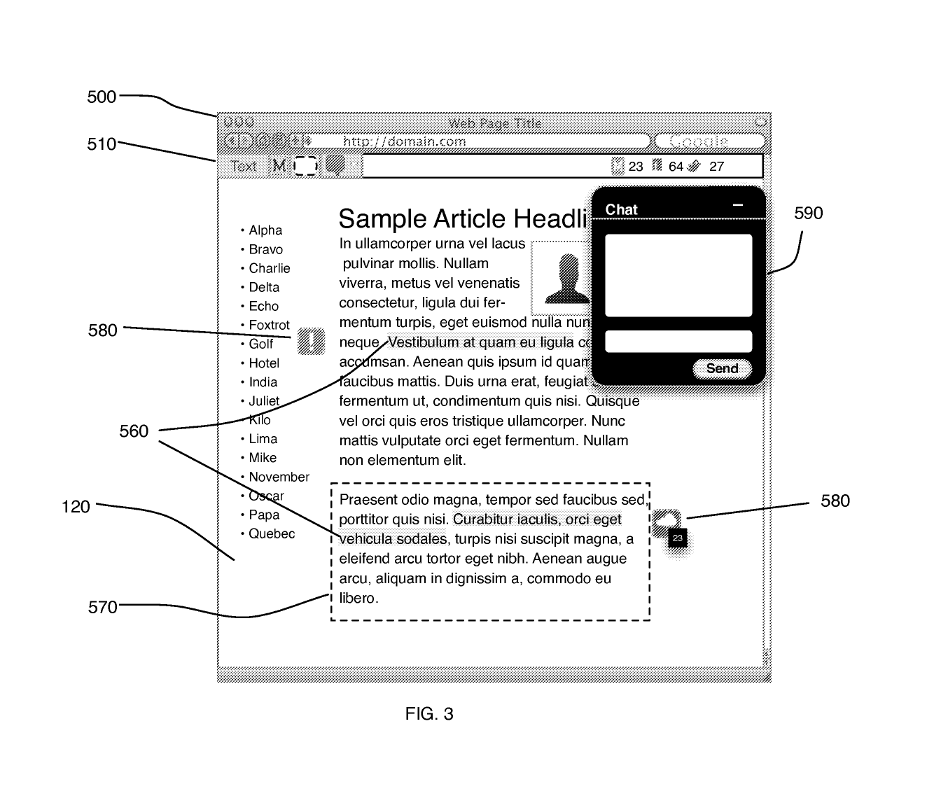

The third-party web page 120 is wrapped so that any user 130 can mark up the third-party web page 120 and see markups from other users 130. FIG. 3 shows an exemplary embodiment of a third-party web page 120 wrapped according to the present invention. As shown in FIG. 3, the third-party web page 120 may be marked up in a variety of ways. As shown in FIG. 3, the third-party web page 120 is displayed in a standard browser 500. A markup toolbar 510 is added above the displayed third-party web page 120. Possible markups include text highlighting 560, boxes 570, image stamps 580, and a chat area 590. Each markup may have selectable attributes. For example, possible text format markup options include highlighted text, bold text, italic text, underlined text, and changing the text color. A box might allow choice of line width, line style, and line color. Other types of markups are also possible, as would be understood by one of ordinary skill in the art. For example, the present invention could add comment fields, “like” buttons, or buttons to share content through other social networks, like Facebook, Twitter, or Tumblr.

When a user places the mouse cursor over a markup, a typical embodiment displays information about the user who created the markup and optionally, when the markup was created. This information preferably includes a link to that user's profile.

In some embodiments, visibility of markups to other users can be limited with access control or other permission rules. In such embodiments, a user can only view markups made by users who have given viewing permission to that user. It is also possible to set permission on a per-markup basis, so that each markup may have an independent access list to identify those who are allowed to view it. Another possibility is to allow the creation of public or private groups of users and grant access to an entire group. This embodiment is particularly useful in academic or professional settings to allow collaboration and sharing among the members of a class, workgroup, department, or other grouping of people.

In order to render a markup without needing to modify server-side source code, the present invention can use a bookmarklet to insert a <script/> tag into the Document Object Model (DOM) of the third-party web page 120. That <script/> tag loads additional Javascript code that can provide a toolbar and render markups. A typical embodiment renders markups by modifying the DOM as needed. For example, to highlight text, a <SPAN/> tag is placed around the text (or if there is an existing SPAN tag, it is modified) to use a custom style. The style is defined by a Cascading Style Sheet (CSS) that is loaded by the Javascript code. Drawing boxes or other images can be done by creating a transparent canvas over the third-party web page 120 and drawing on that canvas. A chat area could be created using an HTML form with an input and submit button, wrapped in a DIV tag. A protocol such as Javascript Object Notation with Padding (JSONP) can be used to retrieve new messages to display in the chat area.

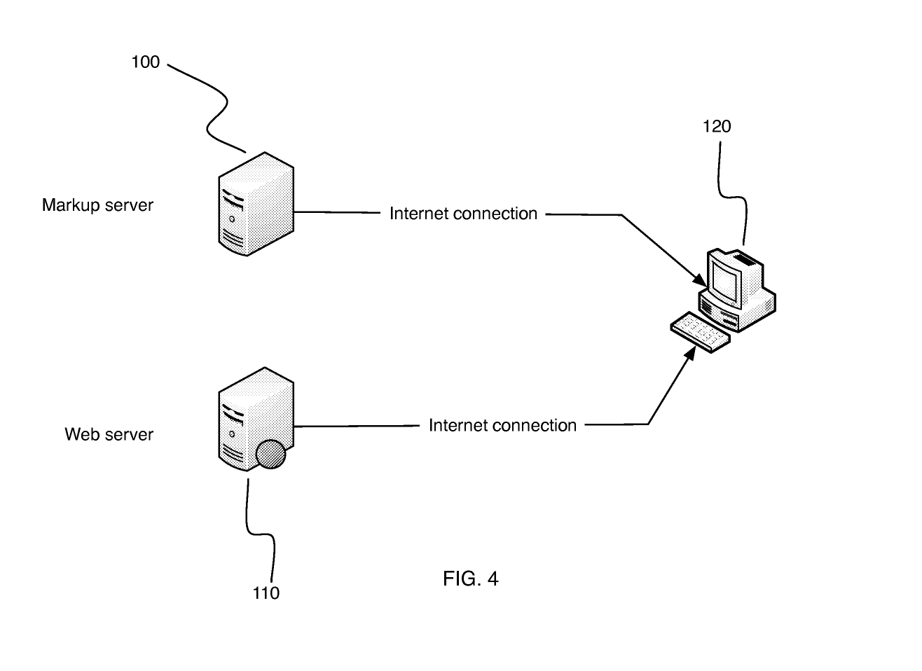

FIG. 4 illustrates a possible hardware configuration of the present invention. The web server 110 is connected through the Internet to a client computer 120. A markup server 100 is also connected through the Internet to the client computer 120. The web server 110 sends web pages and other web content to the client computer 120.

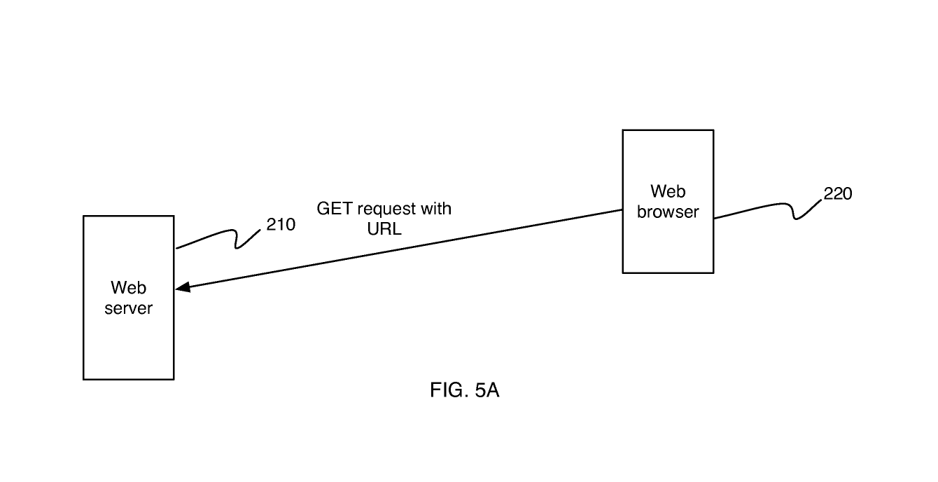

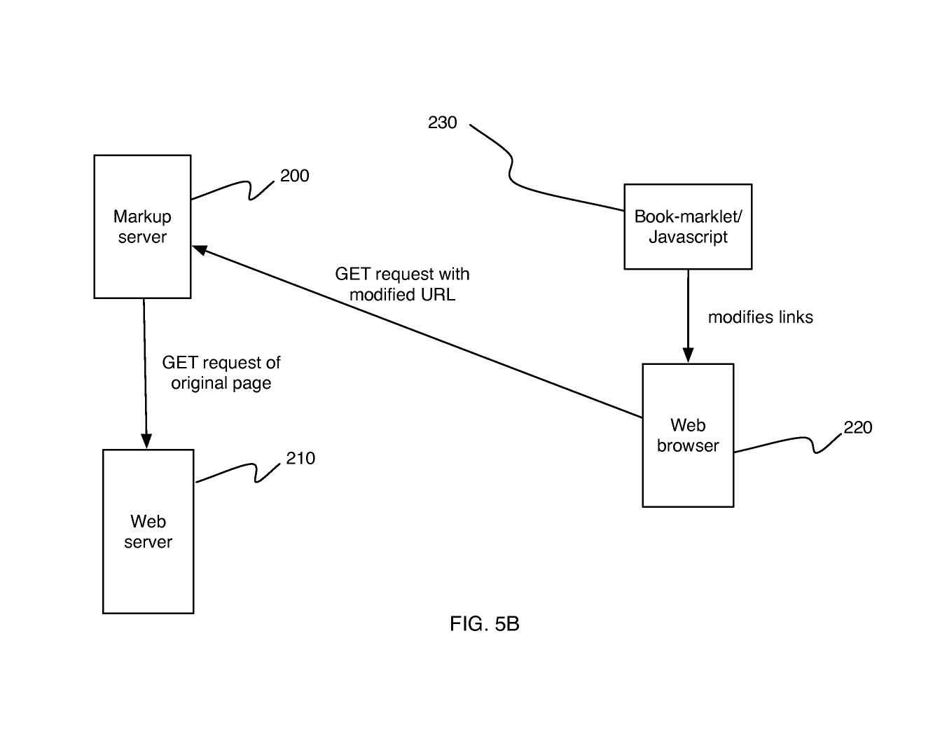

FIG. 5A illustrates a standard software configuration for loading web pages. A web browser 220, such as Firefox®, Safari®, Google Chrome®, or Internet Explorer®, runs on a client computer. The browser 220 sends an HTTP GET request to a web server 210 to request a web page.

FIG. 5B illustrates a possible software configuration of the present invention. A bookmarklet 230 or other plugin runs within the web browser 220. It loads Javascript into the currently displayed web page; that Javascript renders markups and provides tools to the user to mark up the web page. The Javascript modifies hyperlinks on the web page so that they route through the markup server. The modified URLs are described below in more detail.

The web browser 220 sends a request to the markup server 200 identified by the modified URL in order to fetch the desired web page. The markup server 200 requests the original page from the web server 210. It then modifies the web page to add Javascript that renders markup on the web page.

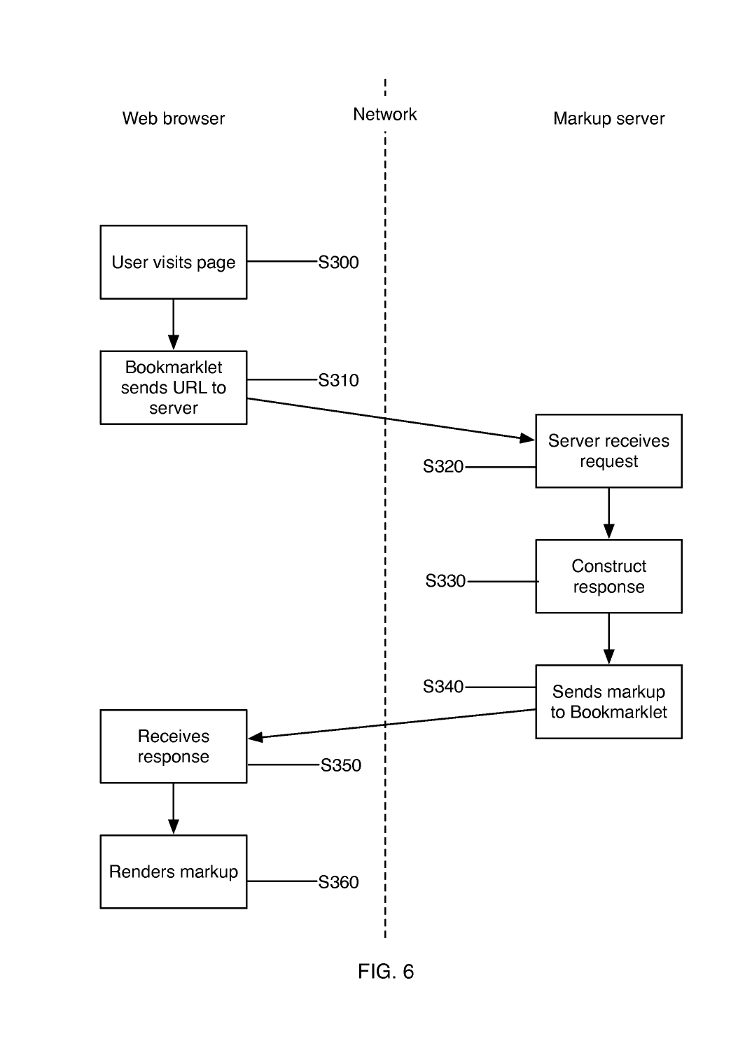

FIG. 6 illustrates a flowchart showing a possible method for displaying markup on a web page. In step S300, a user navigates to a web page using a special URL. In step 310, a bookmarklet sends the URL to a markup server. The URL is an HTTP GET request with data in object notation, prefixed with a callback parameter. A GET request allows passing data via a URL. For example, the markup server and the client could communicate using a protocol such as JSONP.

The GET request is sent to the server signifying a particular action, along with the URL of the page the markup is loaded on. For example, to fetch text highlights for a web page, the action is “get-highlights.” The request could be in the form: http://[API_END_POINT_URL]/?action=get-highlights&url=[CURRENT_PAGE_URL]. The API_END_POINT_URL is the URL of the markup server. CURRENT_PAGE_URL is the URL of the currently viewed web page.

In step S320, the markup server receives the GET request. The markup server parses the GET request to determine the action and the URL of the currently viewed web page.

In step S330, the markup server prepares the response to the GET request. The URL is looked up in a database that stores markup indexed by URL, and corresponding markup data is retrieved from the database. JavaScript Object Notation (JSON) can be used to send data to the bookmarklet. JSON is a text representation of a Javascript data structure. A JSON array containing the markup data appropriate to the request (e.g., text highlights) is constructed. For example, the variables sent could include:

Id: a unique identifier;

Serialize: a code that helps specify where on the page a highlight is located;

Text: the text that was highlighted;

Color: the color that the user chose to highlight the text;

Date: a timestamp that specifies the date that the highlight was made; and

Username: the username of the user that made the highlight.

A standard browser does not allow Javascript to request data from a different domain from the currently displayed web page. One way around this restriction is to wrap the JSON array in a callback function, using JSON with padding (JSONP). A sample JSONP response might look like this (expanded for readability):

callback1640004780281754937055_1340753166726([

{

“id”:”573”,
“serialize”:XXXXXXX,
“text”:“Sample Highlighted Text”,
“color”:“F3F093”,
“date”:“2012-03-24 16:27:57”,
“username”:“crime_fighter_6”,

}

])

The callback wrapper is a random number with a word prefixed (“callback”) in this instance. Once the response is received by the bookmarklet, it is referenced by calling the word+random number combination.

In step S340, the markup server sends the constructed response back to the bookmarklet. In step S350, the bookmarklet receives the response and inserts the received Javascript into the web page. In step S360, the bookmarklet renders the markup on the page.

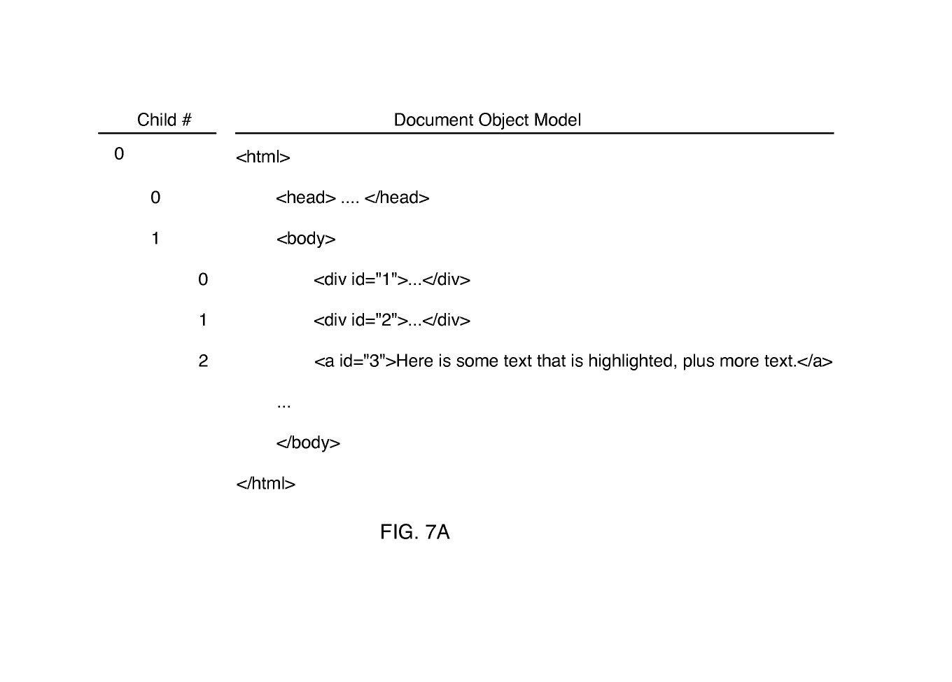

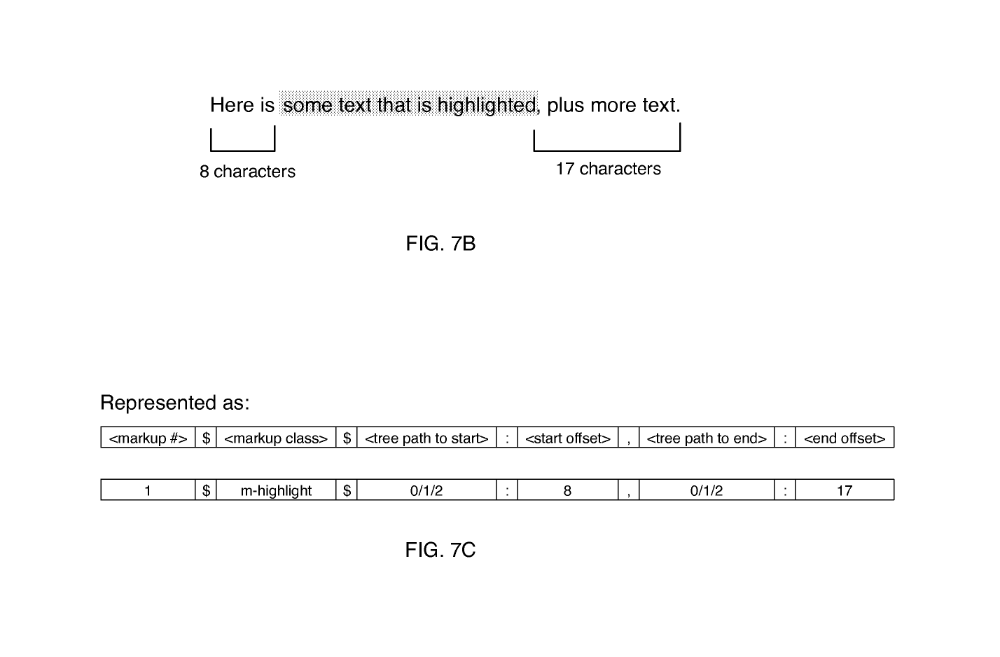

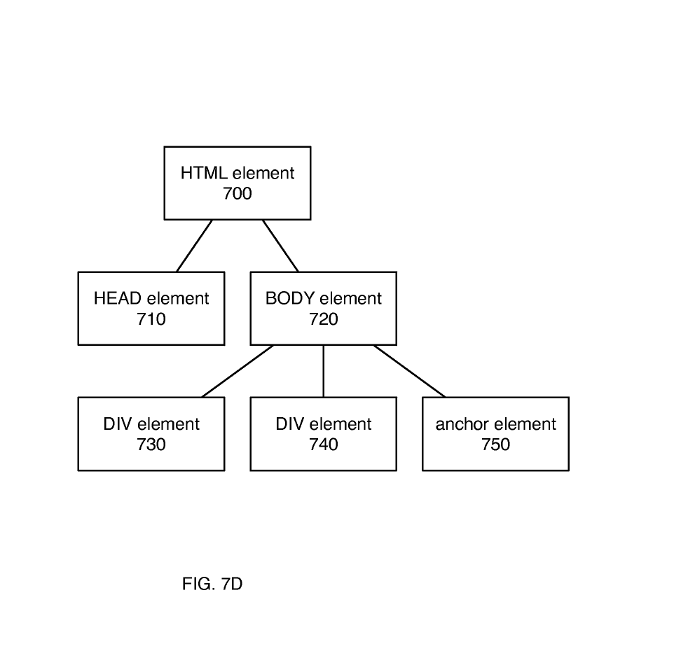

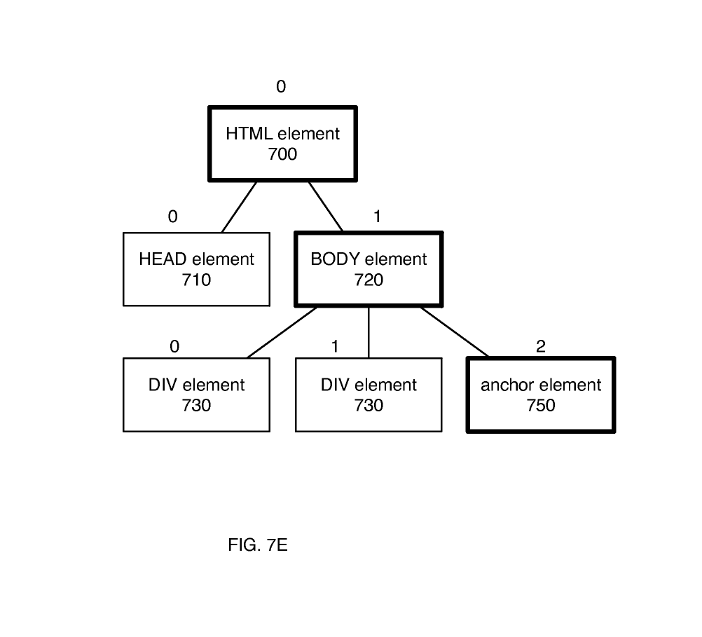

FIGS. 7A-7E illustrate a possible data structure for encoding markups. FIG. 7A shows part of the DOM structure of an example web page. As shown in FIG. 7B, the words “some text that is highlighted” are highlighted when rendered in a web browser. FIG. 7C shows a possible data structure for storing this markup. The upper structure shows the field names, and the lower structure shows the field values for the example in FIGS. 7A and 7B.

Fields are separated by a special character; in the example, a dollar sign ($) is used as a separator. The first field is a number that is unique for this web page to identify the particular markup. In the example, this is the first markup on the page, so it has a markup number of 1. The second field identifies the class of markup, which defines the markup type. In the example, the markup class is “m-highlight,” which identifies the markup as a text highlight. The third field is an index path to the node in the DOM that contains the text to be marked up.

A DOM is a hierarchical structure, generally represented as an n-ary tree. Each node in the tree represents an HTML element, which is HTML that is surrounded by an HTML tag. As shown in FIG. 7D, the example from FIG. 7A includes several elements: a root element 700, which is the HTML tag, a HEAD element 710, a BODY element 720, two DIV elements 730 and an anchor element 750. The HTML root element 700 contains the HEAD element 710 and BODY element 720 as children. The BODY element 720 contains the DIV elements 730 and the anchor element 750 as children.

FIG. 7E shows a path in the tree from the root element 700 to the anchor element 750. For each node, its children are assigned a sequential number starting at 0. The root element 700 is always 0. The BODY element 720 is the second child of the root element 700, so it has the number 1. The anchor element 750 is the third child of the BODY element 720, so it has the number 2. Thus, the path shown in FIG. 7E could be represented by three numbers: 0, 1, 2.

Returning to FIG. 7C, this path 0/1/2 is stored in the third field of the markup data structure. This third field represents the node at the start of the markup. Because a markup might span multiple nodes in the DOM, a similar tree path to the end node is stored in the fifth field of the data structure. The fourth and sixth fields are used to identify the starting and ending points of the text to be marked up within the DOM elements. As shown in FIG. 7B, highlighting starts eight characters after the start of the anchor element 750. The offset from the start of the starting element, which is 8 in the example, is stored in the fourth field of the data structure. The offset from the end of the ending element is stored in the last field of the data structure. As shown in FIG. 7B, the highlighting ends 17 characters before the end of the anchor element 750. Accordingly, the offset 17 is stored in the sixth field of the data structure.

This data structure is merely exemplary. As would be understood by one of ordinary skill in the art, other arrangements are possible. A markup data structure might include other appropriate fields as well. For example, it might include the id of the user who created the markup and/or a timestamp indicating when the markup was created. Other representations of the marked up text are also possible, such as XML tags, objects, or records.

The described embodiments are not intended to be exhaustive descriptions of the present invention. Other variations are also possible, as would be understood by one of ordinary skill in the art.

1. A computer-implemented method for providing a social network for sharing markup of web pages, comprising:
a. providing a software program that runs within a web browser, where the software program is configured to render markup on a web page in response to received instructions;
b. receiving from the software program a URL, wherein the URL comprises parameters, where one of the parameters is a third-party URL;
c. sending a request to a markup database to retrieve previously-created markup of the web page located at the third-party URL;
d. constructing a response containing instructions for rendering the previously-created markup in the web browser; and
e. sending the response containing instructions for rendering the previously-created markup in the web browser to the software program.

2. A computer-implemented method for providing a social network for sharing markup of web pages, comprising:
a. providing a software program that runs within a web browser, where the software program is configured to provide markup tools to a user for marking up a web page;
b. receiving from the software program data representing a markup created by the user, where the data further includes a third-party URL;
c. storing the data in a markup database, where a key for the data is the third-party URL.

3. A system for storing markups of web pages, comprising:
a. a markup server that receives data representing a markup created by a user within a web browser, where the data further includes a third-party URL; and
b. a data storage unit that stores the markup with the third-party URL as a key, using a data structure for storing the markup, wherein the data structure comprises a description of a location within a Document Object Model.
